(19) United States
(12) Patent Application Publication
(10) Pub. No.: US 2002/0105471 A1
(43) Pub. Date: Aug. 8, 2002

(54) Directional switch antenna device

(76) Inventors: Suguru Kojima, Kanagawa (JP); Takashi Enoki, Kanagawa (JP)

Correspondence Address: STEVENS DAVIS MILLER & MOSHER, LLP, 1615 L STREET, NW, SUITE 850, WASHINGTON, DC, 20036, US

(21) Appl. No.: 10/031,460

(22) PCT Filed: May 23, 2001
(86) PCT No.: PCT/JP01/04304

(30) Foreign Application Priority Data
May 24, 2000 (JP) 2000-153215

(51) Int. Cl. H01Q 9/00

(52) U.S. Cl. 343/749; 343/754; 343/819; 343/833; 343/700 MS

(57) ABSTRACT

A directionality switching antenna apparatus of the present invention is provided with radiator 102 in folded form, folded at a length of predetermined length from a feeding point of ground plane 101, with one end thereof connected to the feeding and with the other end thereof shorted with ground plane 101, a plurality of parasitic elements 103 spaced in the vicinity of radiator 102 each with an element length set to provide the parasitic elements with an electrically symmetrical relation to the center axis of radiator 102, inductors 104 loaded on respective parasitic elements 103, diodes 105 connected to ground plane 101, switching elements 106 that connects in parallel respective inductors 104 and respective diodes 105 between respective parasitic elements 103 and ground plane 101. In this way, even when positions of antenna elements become physically asymmetrical with respect to the axis of the radiator, the antenna elements are in electrically symmetrical relation, whereby it is possible to obtain equal radiation characteristics in each radiation direction.

### TECHNICAL FIELD

The present invention relates to a directionality switching apparatus used in a mobile station apparatus and base station apparatus in a mobile communication system.

### BACKGROUND ART

In wireless communications there is a desire to direct radio signals in a specific direction to radiate, and one of antennas for achieving the desire is a yagi antenna. The yagi antenna is one that controls the directionality (radiation direction) by lengths of conductive rods disposed in the vicinity of a half-wavelength dipole antenna.

The yagi antenna uses characteristics that when a parasitic conductive rod (parasitic element) shorter than one-half wavelength is placed in the vicinity of a half-wavelength antenna element as a radiator, signals are radiated in the direction of the conductive rod, while when a parasitic conductive rod (parasitic element) longer than one-half wavelength is placed in the vicinity of such an element, signals are radiated in the opposite direction of the conductive rod.

Generally, an antenna element causing the directionality to direct in the direction thereof is called a director, while an antenna element causing the directionality to direct in the opposite direction thereof is called a reflector. Further, a measure of how well the directionality is obtained is called a gain.

In wireless communications there occurs a case that switching the directionality is needed to minimize the number of mulitpaths on which the direction of arrival varies with propagation environments. As an antenna apparatus capable of switching the directionality, there has been proposed one having a plurality of yagi antenna sequences comprised of three elements, i.e., a reflector, radiator and director.

In addition, a high gain is obtained when a director and reflector are provided at diametrically opposed positions with respect to a radiator to generate the directionality than when either a director or reflector is used to generate the directionality.

Conventionally, one of the directionality switching antenna apparatus is disclosed in Japanese Laid-Open Patent Publication HEI11-27038. In the disclosed antenna apparatus, a plurality of antenna elements is provided in respective radiation directions, and is shared to miniaturize the apparatus.

However, in the conventional apparatus, since the antenna elements are shared, the impedance of the radiator decreases due to the effect of mutual coupling of antenna elements and a matching loss between the feeding line and antenna elements increases.

In order to decrease the matching loss, there is a technique for folding the radiator at a length of generally ¼ wavelength from a feeding point of the ground plane in its folded form with the end thereof shorted with the ground plane, and thereby performing impedance matching.

However, in the antenna apparatus in this technique, since the radiator has the folded form, a center of the radiator to be basically positioned in the perpendicular direction at the feeding point is not positioned in such a perpendicular direction. Therefore, positions of antenna elements angularly spaced around the radiator apart by the same distance from the feeding point as a center become physically asymmetrical with respect to the center axis of the radiator, resulting in a problem that equal radiation characteristics are not obtained in all the radiation directions.

### Disclosure of Invention

It is an object of the present invention to provide a directionality switching antenna apparatus capable of having equal radiation characteristics in all the radiation directions, while using a radiation element in folded form.

The object is achieved by comprising a radiation element in folded form, folded at a length of predetermined wavelength from a feeding point of a ground plane, with one end thereof connected to the feeding point and with the other end thereof shorted with the ground plane, a plurality of parasitic elements, spaced in the vicinity of the radiation element, each having an element length set to provide the parasitic elements with an electrically symmetrical relation to the center axis of the radiation element and being loaded with an inductive element (or capacitive element), and a control circuit that controls switches on or off the inductive element (or capacitive element).

### BRIEF DESCRIPTION OF DRAWINGS

FIG. 1 is a diagram illustrating a configuration of a directionality switching antenna apparatus according to a first embodiment of the present invention;

FIG. 2 is a diagram illustrating a configuration of a directionality switching antenna apparatus according to a second embodiment of the present invention;

FIG. 3 is a diagram illustrating a configuration of a directionality switching antenna apparatus according to a third embodiment of the present invention;

FIG. 4 is a diagram illustrating a configuration of a directionality switching antenna apparatus according to a fourth embodiment of the present invention;

FIG. 5 is a diagram illustrating a configuration of a directionality switching antenna apparatus according to a fifth embodiment of the present invention;

FIG. 6 is a diagram illustrating another configuration of a directionality switching antenna apparatus according to the fifth embodiment of the present invention;

FIG. 7 is a diagram illustrating a configuration of a directionality switching antenna apparatus according to a sixth embodiment of the present invention;

FIG. 8 is a diagram illustrating another configuration of a directionality switching antenna apparatus according to the sixth embodiment of the present invention;

FIG. 9 is a diagram illustrating a configuration of a directionality switching antenna apparatus according to a seventh embodiment of the present invention; and

FIG. 10 is a diagram illustrating a configuration of a directionality switching antenna apparatus according to an eighth embodiment of the present invention.

### BEST MODE FOR CARRYING OUT THE INVENTION

Embodiments of the present invention will be described below with reference to accompanying drawings.

(First Embodiment)

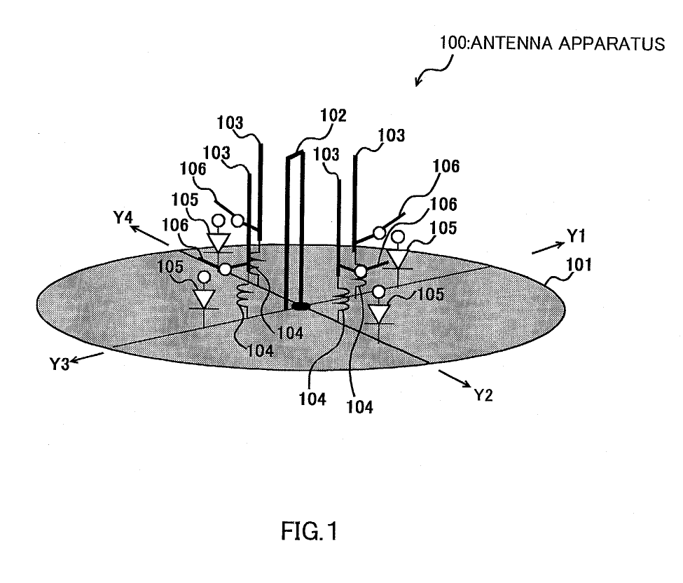

FIG. 1 is a diagram illustrating a configuration of a directionality switching apparatus according to the first embodiment of the present invention.

Antenna apparatus 100 illustrated in FIG. 1 is provided with ground plane 101 made of a conductive material such as a disk-shaped copper plate, radiator 102 in folded from, folded at a length of generally ¼ wavelength from a feeding point as a center of ground plane 101, with a predetermined length thereof parallel to ground plane 101 and with the other end shorted with ground plane 101, four parasitic elements 103 provided symmetrically about the center of ground plane 101, i.e., spaced apart from the center by a predetermined distance, four inductors 104 loaded between respective parasitic elements 103 and ground plane 101, four diodes 105 loaded, in parallel with respective inductors 104, between respective parasitic elements 103 and ground plane 101, and four on/off switching elements 106 connected to respective parasitic elements 103. Antenna elements are provided vertically to ground plane 101.

An electrical length of parasitic element 103 loaded with inductor 104 is hereinafter referred to as an “effective element length”. The effective element length is variable by actuating the function of inductor 104 to “on” or “off” as described below.

When inductor 104 exhibits the original function, i.e., when inductor 104 is functionally coupled (this state is hereinafter referred to as “on”), the effective element length is extended.

Generally, a parasitic element operates as a director when the element is shorter than the radiator, while operating as a reflector when the element is longer than the radiator. In this embodiment, the element length of parasitic element 103 provides the element 103 with the operation as a director when inductor 104 does not exhibit the original function, i.e., when inductor 104 is not functionally coupled (this state is hereinafter referred to as “off”). Meanwhile, when inductor 104 is on, the element length of the element 103 is set to a little shorter than radiator 102 so that the element 103 operates as a reflector. Thus, parasitic element 103 is capable of operating as a reflector or director selectively corresponding to “on” or “off” of the function of inductor 104.

In this way, it is possible to achieve the operations of director and reflector with one antenna element (parasitic element 103), and to miniaturize an antenna apparatus. Further, since radiator 102 has the folded form as described above, it is possible to suppress decreases in impedance due to the mutual coupling of parasitic elements 103, and to match the impedance.

Moreover, as described above, since radiator 102 has the folded form, the entire antenna apparatus is physically asymmetrical. Therefore, the element length of each of parasitic elements 103 is determined corresponding to the distance from the center (middle point of the portion parallel with ground plane 101) of radiator 102, so that the entire antenna apparatus can be provided in electrically symmetrical relation.

In other words, the element length of each of parasitic elements 103 disposed in respective radiation directions Y1 to Y4 is determined corresponding to the distance from the center of radiator 102, whereby antenna gains in diametrical opposed radiation directions about the feeding point become equal to each other (hereinafter referred to as “electrically symmetrical relation”).

Further, in order to actuate the function of inductor 104 to “on” or “off”, parasitic element 103 is connected to a control circuit. The control circuit is provided with, for example, diode 105 connected in parallel with inductor 104, and switching element 106, between parasitic element 103 and ground plane 101.

The operation of antenna apparatus l00 with the above configuration will be described below.

When switching element 106 is on, since a forward current is fed to diode 105, inductor 104 does not exhibit its function (“off”), and parasitic element 103 is not functionally coupled to inductor 104, whereby the effective element length of the element 103 is shorter than radiator 102 and the element 103 operates as a director. On the other hand, when switching element 106 is off, since a current is not fed to diode 105, inductor 104 exhibits its function (“on”), and parasitic element 103 is functionally coupled to inductor 104, whereby the effective element length is extended and longer than radiator 102 and the element 103 operates as a reflector.

Since parasitic elements 103 are disposed in electrically symmetrical relation to the center of radiator 102, each of the elements 103 operates as a director or reflector having the same radiation characteristics in respective radiation direction Y1, Y2, Y3 or Y4. That is, in the case of providing radiation characteristics in direction Y1, respective parasitic elements 103 in directions Y1 to Y4 are controlled as follows; with respect to direction Y1, switching element 106 is made on to make the loaded inductor 104 off, so that the effective element length of parasitic element 103 in direction Y1 is shorter than radiator 102 and thereby the element 103 operates as a director; with respect to direction Y3, switching element 106 is made off to make the loaded inductor 104 on, so that the effective element length of parasitic element 103 in direction Y3 is extended and longer than radiator 102 and thereby the element 103 operates as a reflector; with respect to directions Y2 and Y4, each switching element 106 is made off to make the loaded inductor 104 on, so that each parasitic element 103 operates as a reflector. In the case of providing radiation characteristics in each of directions Y2, Y3 and Y4, the similar operation to the foregoing is performed.

Thus, according to directionality switching antenna apparatus 100 of the first embodiment, each of parasitic elements 103 operates as a director or reflector, and parasitic elements 103 each have the element length determined corresponding to the distance from the center of radiator 102 to be in electrically symmetrical relation. As a result, it is possible to obtain equal radiation characteristics in each radiation direction using radiator 102 even in folded form.

(Second Embodiment)

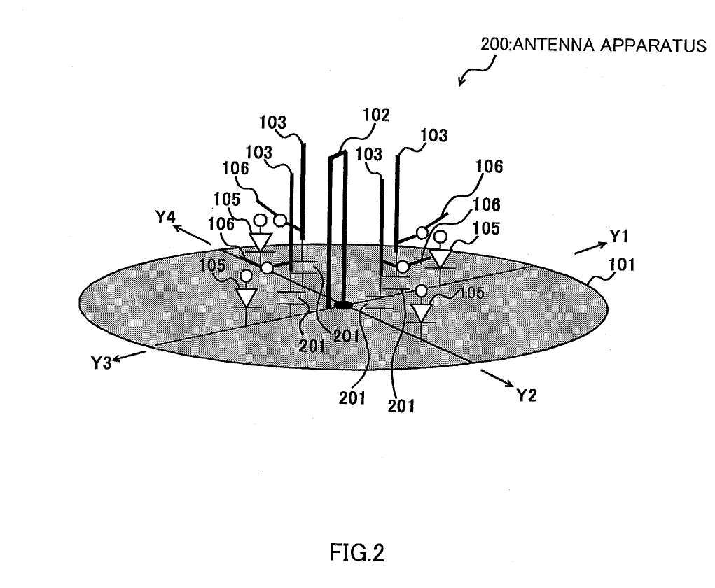

FIG. 2 is a diagram illustrating a configuration of a directionality switching antenna apparatus according to the second embodiment of the present invention. In addition, in FIG. 2 sections corresponding to those in FIG. 1 are assigned the same reference numerals to omit descriptions thereof.

Antenna apparatus 200 illustrated in FIG. 2 is loaded with capacitor 201, instead of inductor 104, and in this respect, differs from antenna apparatus 100 of the first embodiment.

An electrical length of parasitic element 103 loaded with capacitor 201 is hereinafter referred to as an “effective element length”. The effective element length is variable by actuating the function of capacitor 201 to “on” or “off” as described below.

In this configuration, when capacitor 201 exhibits the original function, i.e., when capacitor 201 is functionally coupled (this state is hereinafter referred to as “on”), the effective element length is shortened.

As described previously, generally, a parasitic element operates as a director when the element is shorter than the radiator, while operating as a reflector when the element is longer than the radiator. In this embodiment, the element length of parasitic element 103 provides the element 103 with the operation as a reflector when capacitor 201 does not exhibit the original function, i.e., when capacitor 201 is not functionally coupled (this state is hereinafter referred to as “off”). Meanwhile, when capacitor 201 is on, the element length of the element 103 is set to a little longer than radiator 102 so that the element 103 operates as a director. Thus, parasitic element 103 is capable of operating as a reflector or director selectively corresponding to “on” or “off” of the function of capacitor 201.

Also in this embodiment, since radiator 102 has the folded form, it is possible to suppress decreases in impedance due to the mutual coupling of parasitic elements 103, and to match the impedance, however, the entire antenna apparatus is physically asymmetrical. Therefore, the element length of each of parasitic elements 103 is determined corresponding to the distance from the center (middle point of the portion parallel with ground plane 101) of radiator 102, so that the entire antenna apparatus can be provided in electrically symmetrical relation.

In other words, the element length of each of parasitic elements 103 disposed in respective radiation directions Y1 to Y4 is determined corresponding to the distance from the center of radiator 102, whereby antenna gains in diametrical opposed radiation directions about the feeding point become equal to each other.

Further, as in the first embodiment, in order to actuate the function of capacitor 201 to “on” or “off”, parasitic element 103 is connected to a control circuit. The control circuit is provided with, for example, diode 105 coupled in parallel with capacitor 201, and switching element 106, between parasitic element 103 and ground plane 101.

The operation of antenna apparatus 200 with the above configuration will be described below.

When switching element 106 is on, since a forward current is fed to diode 105, capacitor 201 does not exhibit its function (“off”), and parasitic element 103 is not functionally coupled to capacitor 201, whereby the effective element length of the element 103 is longer than radiator 102 and thereby the element 103 operates as a reflector. On the other hand, when switching element 106 is off, since a current is not fed to diode 105, capacitor 201 exhibits its function (“on”), and parasitic element 103 is functionally coupled to capacitor 201, whereby the effective element length is decreased and shorter than radiator 102 and the element 103 operates as a director.

Since parasitic elements 103 are disposed in electrically symmetrical relation to the center of radiator 102, each of the elements 103 operates as a director or reflector having the same radiation characteristics in respective radiation direction Y1, Y2, Y3 or Y4. That is, in the case of providing radiation characteristics in direction Y1, respective parasitic elements 103 in directions Y1 to Y4 are controlled as follows; with respect to direction Y1, switching element 106 is made off to make the loaded capacitor 201 on, so that parasitic element 103 in direction Y1 operates as a director; with respect to direction Y3, switching element 106 is made on to make the loaded capacitor 201 off, so that parasitic element 103 in direction Y3 operates as a reflector; with respect to directions Y2 and Y4, each switching element 106 is made off to make the loaded capacitor 201 on, so that each parasitic element 103 operates as a director. In the case of providing radiation characteristics in each of directions Y2, Y3 and Y4, the similar operation to the foregoing is performed.

Thus, according to directionality switching antenna apparatus 200 of the second embodiment, each of parasitic elements 103 operates as a director or reflector, and parasitic elements 103 each have the element length determined corresponding to the distance from the center of radiator 102 to be in electrically symmetrical relation. As a result, it is possible to obtain equal radiation characteristics in each radiation direction using radiator 102 in even folded form.

(Third Embodiment)

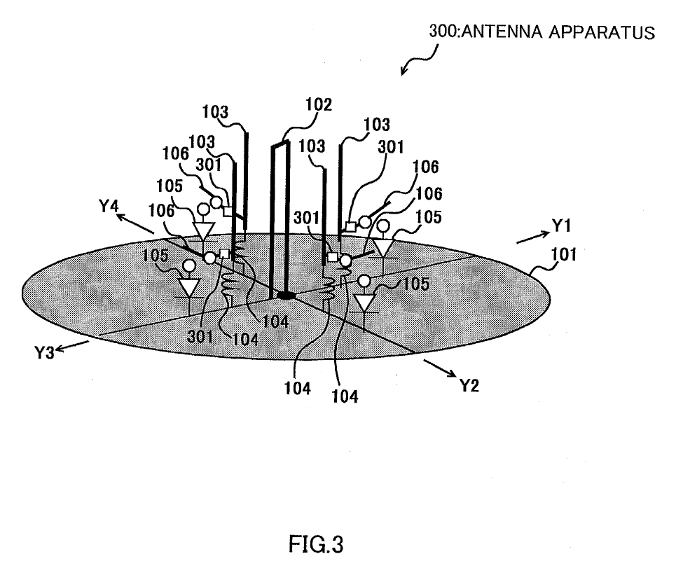

FIG. 3 is a diagram illustrating a configuration of a directionality switching antenna apparatus according to the third embodiment of the present invention. In addition, in FIG. 3 sections corresponding to those in FIG. 1 are assigned the same reference numerals as in FIG. 1 to omit descriptions thereof.

Antenna apparatus 300 illustrated in FIG. 3 differs from antenna apparatus 100 in the first embodiment in respects that parasitic elements 103 each have the same length, and that central constant circuit 301 is loaded between each pair of parasitic element 103 and switching element 106. It is assumed that parasitic element 103 has the length to operate as a director when switching element 106 is on, while having the length to operate as a reflector when switching element 106 is off.

Also in this embodiment, since radiator 102 has the folded form, it is possible to suppress decreases in impedance due to the mutual coupling of parasitic elements 103, and to match the impedance, however, the entire antenna apparatus is physically asymmetrical. Therefore, respective constants of central constant circuits 301 and inductors 104 are determined corresponding to distance from the center of radiator 102 to respective parasitic elements 103, so that the entire antenna apparatus can be provided in electrically symmetrical relation.

In this case, when each parasitic element 103 operates as a reflector, the constant of inductor 104 loaded on the element 103 is set to a value providing the elements 103 with electrically symmetrical relation to the center axis of radiator 102.

Further, when each parasitic element 103 operates as a director, the constant of central constant circuit 301 loaded on the element 103 is set to a value providing the elements 103 with electrically symmetrical relation to the center axis of radiator 102.

The operation of antenna apparatus 300 with the above configuration will be described below.

When switching element 106 is on, since a forward current is fed to diode 105, inductor 104 does not exhibit its function (“off”), and parasitic element 103 is not functionally coupled to inductor 104, whereby the effective element length of the element 103 is shorter than radiator 102 and the element 103 operates as a director. At this point, the predetermined constant of central constant circuit 301 affects parasitic element 103. On the other hand, when switching element 106 is off, since a current is not fed to diode 105, inductor 104 exhibits its function (“on”), and parasitic element 103 is functionally coupled to inductor 104, whereby the effective element length is extended and longer than radiator 102 and the element 103 operates as a reflector.

Since parasitic elements 103 are disposed in electrically symmetrical relation to the center of radiator 102, each of the elements 103 operates as a director or reflector having the same radiation characteristics in respective radiation direction Y1, Y2, Y3 or Y4. That is, in the case of providing radiation characteristics in direction Y1, respective parasitic elements 103 in directions Y1 to Y4 are controlled as follows; with respect to direction Y1, switching element 106 is made on to make the loaded inductor 104 off, so that the element 103 operates as a director; with respect to direction Y3, switching element 106 is made off to make the loaded inductor 104 on, so that the element 103 operates as a reflector; with respect to directions Y2 and Y4, each switching element 106 is made off to make the loaded inductor 104 on, so that each parasitic element 103 operates as a reflector. In the case of providing radiation characteristics in each of directions Y2, Y3 and Y4, the similar operation to the foregoing is performed.

Thus, according to directionality switching antenna apparatus 300 of the third embodiment, when each switching element is off, inductor 104 is set for the constant providing the elements 103 with electrically symmetrical relation to the center axis of radiator 102. Meanwhile, when each switching element is on, central constant circuit 301 is set for the constant providing the elements 103 with electrically symmetrical relation to the center axis of radiator 102. As a result, it is possible to obtain equal radiation characteristics in each radiation direction using radiator 102 even in folded form.

(Fourth Embodiment)

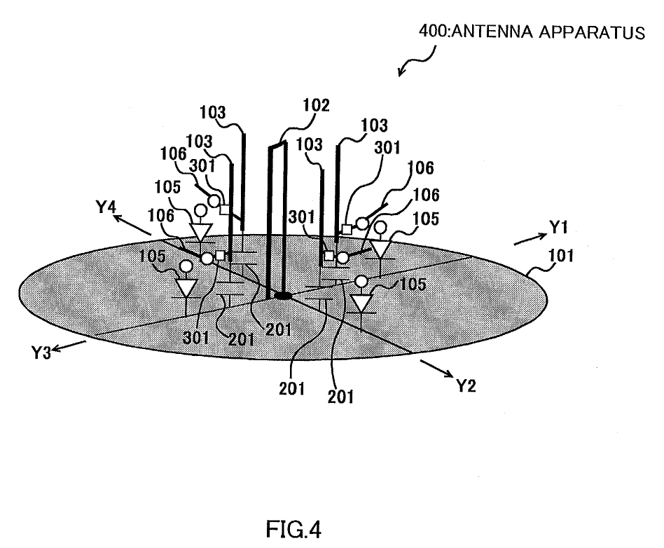

FIG. 4 is a diagram illustrating a configuration of a directionality switching antenna apparatus according to the fourth embodiment of the present invention. In addition, in FIG. 4 sections corresponding to those in FIG. 3 are assigned the same reference numerals as in FIG. 3 to omit descriptions thereof.

Antenna apparatus 400 illustrated in FIG. 4 is loaded with capacitor 201, instead of inductor 104, and in this respect, differs from antenna apparatus 300 in the third embodiment.

Also in this embodiment, since radiator 102 has the folded form, it is possible to suppress decreases in impedance due to the mutual coupling of parasitic elements 103, and to match the impedance, however, the entire antenna apparatus is physically asymmetrical. Therefore, respective constants of capacitors 201 and central constant circuits 301 are determined corresponding to distance from the center of radiator 102 to respective parasitic elements 103, so that the entire antenna apparatus can be provided in electrically symmetrical relation.

In this case, when each parasitic element 103 operates as a director, the constant of capacitor 201 loaded on the element 103 is set to a value providing the elements 103 with electrically symmetrical relation to the center axis of radiator 102.

Further, when each parasitic element 103 operates as a reflector, the constant of central constant circuit 301 loaded with the element 103 is set to a value providing the elements 103 with electrically symmetrical relation to the center axis of radiator 102.

The operation of antenna apparatus 400 with the above configuration will be described below.

When switching element 106 is on, since a forward current is fed to diode 105, capacitor 201 does not exhibit its function (“off”), and parasitic element 103 is not functionally coupled to capacitor 201, whereby the effective element length of the element 103 is longer than radiator 102 and the element 103 operates as a reflector. At this point, the predetermined constant of central constant circuit 301 affects parasitic element 103. On the other hand, when switching element 106 is off, since a current is not fed to diode 105, capacitor 201 exhibits its function (“on”), and parasitic element 103 is functionally coupled to capacitor 201, whereby the effective element length is decreased and shorter than radiator 102 and the element 103 operates as a director.

Since parasitic elements 103 are disposed in electrically symmetrical relation to the center of radiator 102, each of the elements 103 operates as a director or reflector having the same radiation characteristics in respective radiation direction Y1, Y2, Y3 or Y4. That is, in the case of providing radiation characteristics in direction Y1, respective parasitic elements 103 in directions Y1 to Y4 are controlled as follows; with respect to direction Y1, switching element 106 is made off to make the loaded capacitor 201 on, so that the element 103 operates as a director; with respect to direction Y3, switching element 106 is made on to make the loaded capacitor 201 off, so that the element 103 operates as a reflector; with respect to directions Y2 and Y4, each switching element 106 is made off to make the loaded capacitor 201 on, so that each parasitic element 103 operates as a director. In the case of providing radiation characteristics in each of directions Y2, Y3 and Y4, the similar operation to the foregoing is performed.

Thus, according to directionality switching antenna apparatus 400 of the fourth embodiment, when each switching element is off, capacitor 201 is set for the constant providing the elements 103 with electrically symmetrical relation to the center axis of radiator 102. Meanwhile, when each switching element is on, central constant circuit 301 is set for the constant providing the elements 103 with electrically symmetrical relation to the center axis of radiator 102. As a result, it is possible to obtain equal radiation characteristics in each radiation direction using radiator 102 even in folded form.

(Fifth Embodiment)

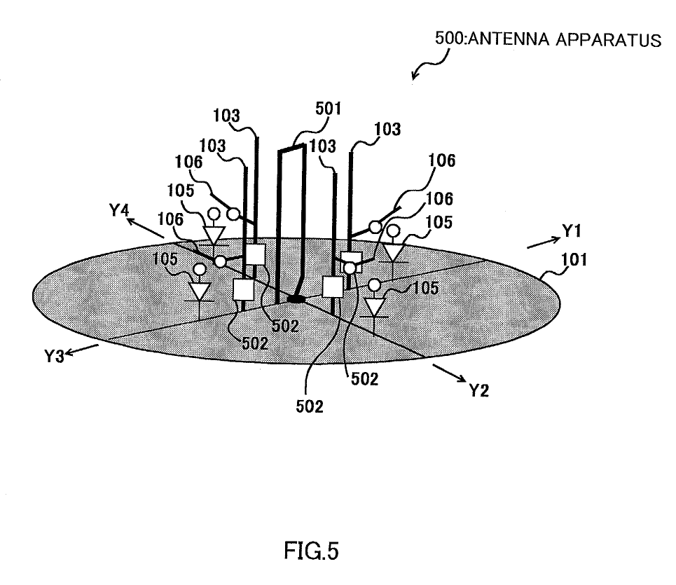

FIG. 5 is a diagram illustrating a configuration of a directionality switching antenna apparatus according to the fifth embodiment of the present invention. In addition, in FIG. 5 sections corresponding to those in FIG. 1 are assigned the same reference numerals as in FIG. 1 to omit descriptions thereof.

Antenna apparatus 500 illustrated in FIG. 5 differs from antenna apparatus 100 in the first embodiment in respects that radiator 501 has a different folded form, parasitic elements 103 each have the same length, and that central constant circuit 502 is loaded between each pair of parasitic element 103 and switching element 106. Central constant circuit 502 is composed of a circuit having either an inductor or capacitor with the same constant.

An electrical length of parasitic element 103 loaded with central constant circuit 502 is hereinafter referred to as an “effective element length”. The effective element length is variable by actuating the function of central constant circuit 502 to “on” or “off” as described below.

It is assumed in this embodiment that central constant circuit 502 is comprised of an inductor, parasitic element 103 has the length to operate as a reflector when switching element 106 is off, while having the length to operate as a director when switching element 106 is on.

Specifically, due to central constant circuit 502, when switching element 106 is off, parasitic element 103 has the extended effective element length longer than radiator 501 and thereby operates as a reflector, while when switching element 106 is on, having the effective element length shorter than radiator 501 and thereby operating as a director. In addition, central constant circuit 502 may be comprised of a capacitor to operate parasitic element 103 as a director when switching element is off, while operating parasitic element 103 as a reflector when switching element 106 is on. In this case, the length of parasitic element 103 is made a little longer than radiator 501.

Radiator 501 has the folded form similar to that described in the first embodiment except that the rising portion from the feeding point of ground plane 101 rises slantwise in direction Y1 and then extends perpendicularly so that the center of antenna is positioned in the perpendicular direction at the feeding point.

Therefore, positions of parasitic elements 103 angularly spaced around radiator 501 apart by the same distance from the feeding point as a center become physically symmetrical about the center axis of radiator 501, and it is thereby possible to obtain equal radiation characteristics in each of radiation directions Y1 to Y4. That is, in the case of providing radiation characteristics in direction Y1, respective parasitic elements 103 in directions Y1 to Y4 are controlled as follows; with respect to direction Y1, switching element 106 is made on and the element 103 operates as a director; with respect to direction Y3, switching element 106 is made off, and the element 103 has the extended effective element length due to the function of central constant circuit and thereby operations as a reflector; with respect to directions Y2 and Y4, each switching element 106 is made off, and each parasitic element 103 operates as a reflector due to the function of the loaded central constant circuit 502. In the case of providing radiation characteristics in each of directions Y2, Y3 and Y4, the similar operation to the foregoing is performed.

Thus, according to directionality switching antenna apparatus 500 in the fifth embodiment, radiator 501 has the folded form such that the rising portion from the feeding point of ground plane 101 rises slantwise in direction Y1 and then extends perpendicularly so that the center of antenna is positioned in the perpendicular direction at the feeding point.

In this way positions of parasitic elements 103 angularly spaced around radiator 501 apart by the same distance from the feeding point as a center become physically symmetrical about the center axis of radiator 501, and it is thereby possible to obtain equal radiation characteristics in each of radiation directions Y1 to Y4.

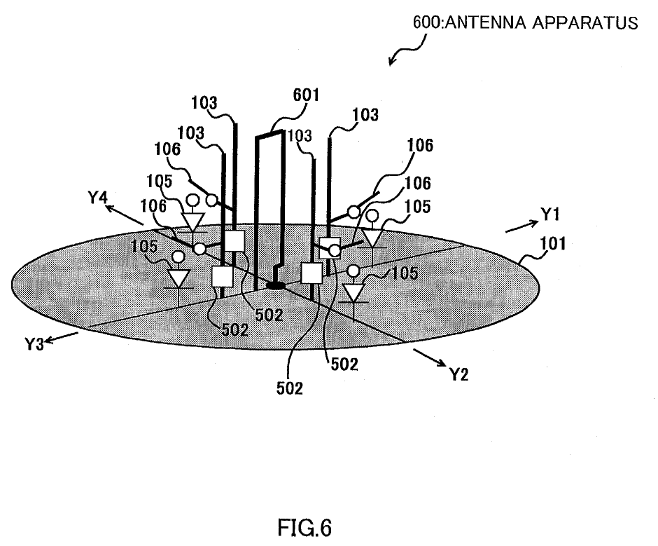

Further, radiator 501 requires in form only that the center thereof is positioned in the perpendicular direction at the feeding point, and radiator 601 in the form as illustrated in FIG. 6 is capable of obtaining the same effectiveness as the foregoing. Specifically, while radiator 501 has the slant rising portion, radiator 601 has the form such that the rising portion extends perpendicularly first, then extends by a predetermined distance in the direction parallel to Y1, and rises perpendicularly.

(Sixth Embodiment)

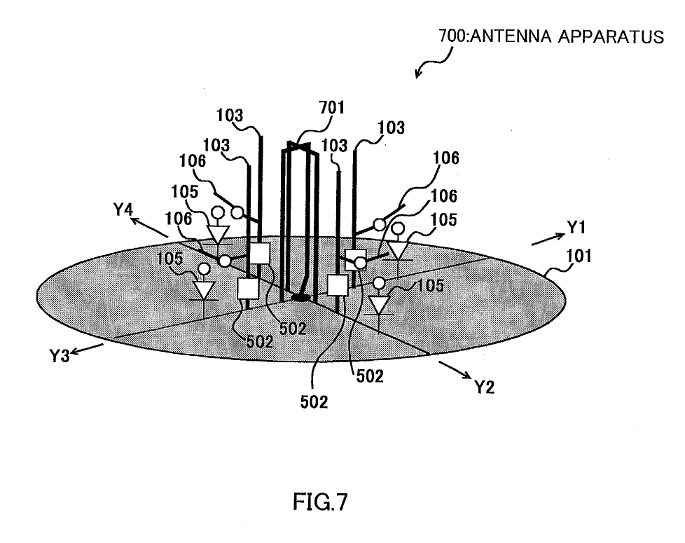

FIG. 7 is a diagram illustrating a configuration of a directionality switching antenna apparatus according to the sixth embodiment of the present invention. In addition, in FIG. 7 sections corresponding to those in FIG. 5 are assigned the same reference numerals as in FIG. 5 to omit descriptions thereof.

Antenna apparatus 700 illustrated in FIG. 7 differs from antenna apparatus 500 of the fifth embodiment in the respect that radiator 701 has such a form that folded elements in directions Y1 and Y3 are connected in the perpendicular direction at the feeding point to folded elements in directions Y2 and Y4.

Also in this case, positions of parasitic elements 103 angularly spaced around radiator 701 apart by the same distance from the feeding point as a center become physically symmetrical about the center axis of radiator 701, and it is thereby possible to obtain equal radiation characteristics in each of radiation directions Y1 to Y4.

In addition while radiator 701 is comprised of four elements, it may be possible that radiator 701 is comprised of n elements corresponding to the impedance of the radiator or the number of sectors.

Thus, according to directionality switching antenna apparatus 700 of the sixth embodiment, since positions of parasitic elements 103 angularly spaced around radiator 701 apart by the same distance from the feeding point as a center become physically symmetrical about the center axis of radiator 701, it is possible to obtain equal radiation characteristics in each of radiation directions Y1 to Y4.

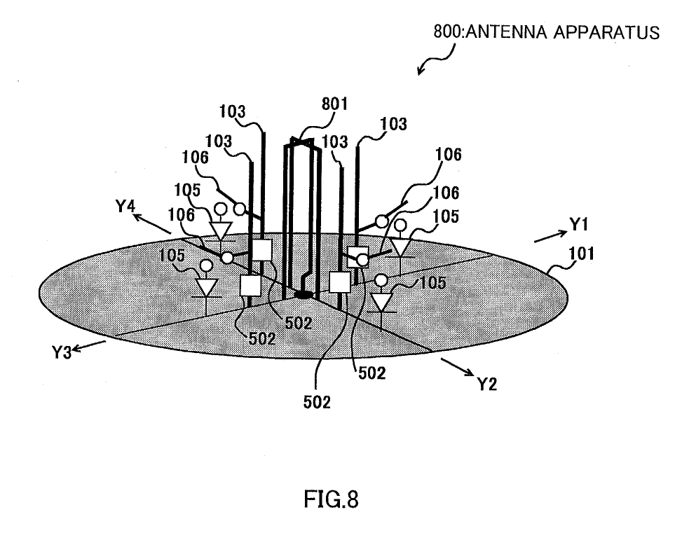

Further, radiator 701 requires in form only that the center thereof is positioned in the perpendicular direction at the feeding point, and radiator 801 in the form as illustrated in FIG. 8 is capable of obtaining the same effectiveness as the foregoing. Specifically, while radiator 701 has the slant rising portion, radiator 801 has the form such that the rising portion extends perpendicularly first, then extends by a predetermined distance in the direction parallel to Y1, and rises perpendicularly.

(Seventh Embodiment)

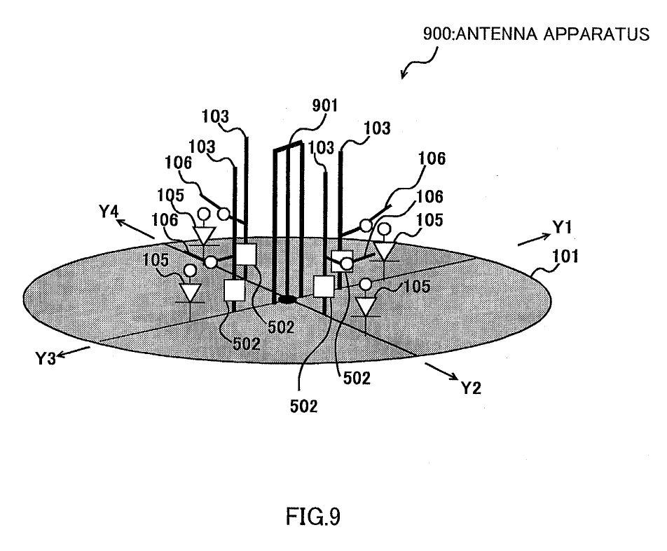

FIG. 9 is a diagram illustrating a configuration of a directionality switching antenna apparatus according to the seventh embodiment of the present invention. In addition, in FIG. 9 sections corresponding to those in FIG. 5 are assigned the same reference numerals as in FIG. 5 to omit descriptions thereof.

Antenna apparatus 900 illustrated in FIG. 9 differs from antenna apparatus 500 of the fifth embodiment in the respect that radiator 901 has such a folded form that the element rises perpendicularly from the feeding point of ground plane 101, and extends in respective directions parallel to Y1 and Y3 by the same distance, and each extended element falls perpendicularly to be shorted with ground plane 101.

In this way positions of parasitic elements 103 angularly spaced around radiator 901 apart by the same distance from the feeding point as a center become physically symmetrical about the center axis of radiator 901, and it is thereby possible to obtain equal radiation characteristics in each of radiation directions Y1 to Y4.

Thus, according to directionality switching antenna apparatus 900 of the seventh embodiment, since positions of parasitic elements 103 angularly spaced around radiator 901 apart by the same distance from the feeding point as a center become physically symmetrical about the center axis of radiator 901, it is possible to obtain equal radiation characteristics in each of radiation directions Y1 to Y4.

(Eighth Embodiment)

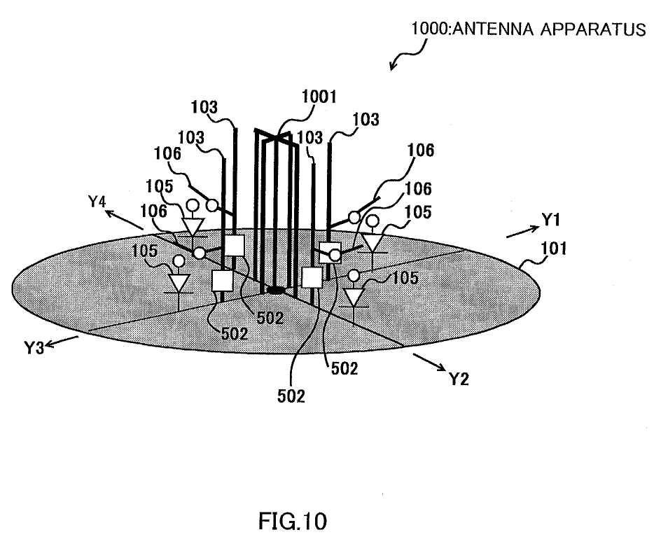

FIG. 10 is a diagram illustrating a configuration of a directionality switching antenna apparatus according to the eighth embodiment of the present invention. In addition, in FIG. 10 sections corresponding to those in FIG. 9 are assigned the same reference numerals as in FIG. 9 to omit descriptions thereof.

Antenna apparatus 1000 illustrated in FIG. 10 differs from antenna apparatus 900 of the seventh embodiment in the respect that radiator 1001 has such a folded form that the element rises perpendicularly from the feeding point of ground plane 101, and extends in respective directions parallel to Y1 to Y4 by the same distance, and each extended element falls perpendicularly to be shorted with ground plane 101.

Also in this case, since positions of parasitic elements 103 angularly spaced around radiator 1001 apart by the same distance from the feeding point as a center become physically symmetrical about the center axis of radiator 1001, it is possible to obtain equal radiation characteristics in each of radiation directions Y1 to Y4.

In addition while radiator 1001 is comprised of five elements, it may be possible that radiator 1001 is comprised of n elements corresponding to the impedance of the radiator or the number of sectors.

Thus, according to directionality switching antenna apparatus 1000 of the eighth embodiment, since positions of parasitic elements 103 angularly spaced around radiator 1001 apart by the same distance from the feeding point as a center become physically symmetrical about the center axis of radiator 1001, it is possible to obtain equal radiation characteristics in each of radiation directions Y1 to Y4.

Further, in addition to the foregoing, it may be possible to vary each of a length of the parasitic element and a value of the constant of the central constant circuit corresponding to a distance of the element from the radiator.

Furthermore, it may be possible to vary arbitrarily a thickness (diameter) of a folded portion in the radiator. Adopting an arbitrary thickness varies the impedance to obtain impedance matching.

Terminology of “perpendicular” in the above description does not mean exactly 90 degrees and means generally 90 degrees, which is the same as in the scope of claims.

As can be apparent from the foregoing, according to the present invention, in a configuration where a radiator in the folded form is disposed at the center of a ground plane and a plurality of antenna elements is spaced around the radiator, even when respective positions of the antenna elements become physically asymmetrical with respect to the center axis of the radiator, it is possible to obtain equal characteristics in each of radiation directions.

This application is based on the Japanese Patent Application No. 2000-153215 filed on May 24, 2000, entire content of which is expressly incorporated by reference herein.

### Industrial Applicability

The present invention is suitable for use in mobile station apparatuses and base station apparatuses in a mobile communication system.

1. A directionality switching antenna apparatus comprising:
a radiation element in folded form, folded at a length of predetermined wavelength from a feeding point of a ground plane, with one end thereof connected to the feeding point and with the other end thereof shorted with the ground plane;
a plurality of parasitic elements spaced in the vicinity of the radiation element, each having an element length set to provide the parasitic elements with an electrically symmetrical relation to the center axis of the radiation element and being loaded with one of inductive elements; and
a plurality of control circuits that switches on or off the function of one of the inductive elements.

2. A directionality switching antenna apparatus comprising:
a radiation element in folded form, folded at a length of predetermined wavelength from a feeding point of a ground plane, with one end thereof connected to the feeding point and with the other end thereof shorted with the ground plane;
a plurality of parasitic elements spaced in the vicinity of the radiation element, each having an element length set to provide the parasitic elements with an electrically symmetrical relation to the center axis of the radiation element and being loaded with one of capacitive element; and
a plurality of control circuits that switches on or off the function of one of the capacitive elements.

3. A directionality switching antenna apparatus comprising:
a radiation element in folded form, folded at a length of predetermined wavelength from a feeding point of a ground plane, with one end thereof connected to the feeding point and with the other end thereof shorted with the ground plane;
a plurality of parasitic elements spaced in the vicinity of the radiation element, each loaded with an inductive element set for a constant providing the parasitic elements with an electrically symmetrical relation to the center axis of the radiation element;
a plurality of control circuits that switches on or off the function of one of the inductive elements; and
a plurality of central constant circuits, each of which is connected to one of the control circuits, and is set for a constant providing the parasitic elements with the electrically symmetrical relation to the center axis of the radiation element.

4. A directionality switching antenna apparatus comprising:
a radiation element in folded form, folded at a length of predetermined wavelength from a feeding point of a ground plane, with one end thereof connected to the feeding point and with the other end thereof shorted with the ground plane;
a plurality of parasitic elements spaced in the vicinity of the radiation element, each loaded with a capacitive element set for a constant providing the parasitic elements with an electrically symmetrical relation to the center axis of the radiation element; and
a plurality of control circuits that switches on or off the function of one of the capacitive element; and
a plurality of central constant circuits, each of which is connected to the control circuits, and is set for a constant providing the parasitic elements with the electrically symmetric relation to the center axis of the radiation element.

5. A directionality switching antenna apparatus comprising:
a radiation element in folded form, folded at a length of predetermined wavelength from a feeding point of a ground plane, with one end thereof connected to the feeding point, with the other end thereof shorted with the ground plane, and with a portion rising from the feeding point folded so that the center of the antenna is positioned in the perpendicular direction at the feeding point;
a plurality of parasitic elements spaced in the vicinity of the radiation element;
a central constant circuit loaded on each of the parasitic elements;
a plurality of control circuits that switches on or off the function of one of the central constant elements.

6. A directionality switching antenna apparatus comprising:
a first radiation element in folded form, folded at a length of predetermined wavelength from a feeding point of a ground plane, with one end thereof connected to the feeding point, with the other end thereof shorted with the ground plane, and with a portion rising from the feeding point folded so that the center of the antenna is positioned in the perpendicular direction at the feeding point; and
a second radiation element in folded form, formed to be connected at the center of the first radiation element to the first radiation element.

7. A directionality switching antenna apparatus comprising:
a radiation element in folded form, with one end thereof connected to a feeding point of a ground plane, folded at a length of predetermined wavelength to have a plurality of branches with each end of the branches shorted with the ground plane, positions of the branches symmetrical with respect to the axis of a portion rising from the feeding point;
a plurality of parasitic elements spaced in the vicinity of the radiation element;
a central constant circuit loaded on each of the parasitic elements is loaded; and
a plurality of control circuits that switches on or off the function of one of the central constant circuits.

8. A mobile station apparatus comprising the directionality switching antenna apparatus of claims 1.

9. A base station apparatus comprising the directionality switching antenna apparatus of claims 1.
